(19) United States
(12) Patent Application Publication
(10) Pub. No.: US 2006/0256489 A1
(43) Pub. Date: Nov. 16, 2006

(54) ESD protection circuits with impedance matching for radio-frequency applications

(75) Inventors: Ming-Dou Ker, Hsinchu (TW); Cheng-Ming Lee, Hsinchu (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Taiwan Semiconductor Manufacturing Co., Ltd.

(21) Appl. No.: 11/126,134

(22) Filed: May 10, 2005

(51) Int. Cl. H02H 9/00

(52) U.S. Cl. 361/56

(57) ABSTRACT

An ESD protection circuit with impedance matching for radio frequency integrated circuits is provided. Nodes at the ends of a transmission line, respectively have at least one ESD component coupled between each and one of the power rails. The ESD components discharge ESD currents and the transmission lines provide RF matching.

### BACKGROUND

The present invention relates in general to Eelectro-Static Discharge(ESD) protection, and more particularly to ESD protection circuits with impedance matching.

In a Human Body Mode (HBM) ESD event, several hundred volts can be transferred from an operator to a circuit in about 100 ns. This high voltage transition can break down gate oxide at the input stage of the circuit and can cause malfunction of the circuit. As the thickness of the gate oxide decreases, it is important to provide a protection circuit or device to protect the gate oxide.

As shown in FIG. 1, conventional ESD protection design uses a two-staged protection structure for digital integrated circuits (ICs). Between the primary stage 12 and the secondary stage 11 of the input ESD protection circuit, a resistor R is added to limit ESD current through a short-channel NMOS 11 in the secondary stage. The resistance value of the resistor R is dependent on the turn-on voltage of the ESD clamp device 12 in the primary stage and secondary breakdown current of the short-channel NMOS 11 in the secondary stage. Such two-staged ESD protection provides high ESD prevention levels for digital input pins. The large series resistance and the large junction capacitance in the ESD clamp devices, however, cause a long RC time delay to an input signal, such that it is no longer suitable for analog pin use, especially for RF signal applications.

For RF signal applications, the equivalent capacitance of ESD clamp devices degrades power transfer from input pad to internal RF low noise amplifier (LNA), lowering the power gain of the LNA circuits and increasing noise. It is thus necessary to reduce the effect of equivalent capacitance of ESD clamp devices on RF LNA circuits, in the interest of which, numerous protection circuits have been proposed.

FIGS. 2A-2D show four ESD stress modes integrated circuits may encounter. The four ESD stress modes in FIGS. 2A-2D are PS, NS, PD and ND mode, respectively. In FIG. 3, in order to reduce loading capacitance of the input pin in RF circuits, protection diodes present small device dimension. If the diode NDIO (or PDIO) under the PS-mode (or ND-mode) ESD stress is operated in junction breakdown mode to discharge ESD current, such that low ESD level is typically achieved. To prevent the small diodes from operating in breakdown condition during the PS-mode and ND-mode ESD stresses and lowering ESD level, a turn-on efficient ESD clamp circuit 32 between power rails is integrated into the ESD protection circuit. This tends to significantly increase the overall ESD level.

When the RF input pin encounters ESD pulse in NS-mode (PD-mode), the NDIO (PDIO) is operated in the forward-biased condition to discharge ESD current. The diode in the forward-biased condition can sustain a much higher ESD level than when in reverse-biased breakdown condition. The RC-biased ESD detection circuit triggers the device MNESD when the RF input pad experiences PS-mode or ND-mode ESD stress. ESD current paths in this RF ESD protection under PS-mode and ND-mode ESD stress are illustrated by the dashed lines in FIG. 4 and FIG. 5 respectively. Because the diode NDIO in the PS-mode ESD stress is not in breakdown condition, the ESD current I_{esd} is bypassed through the forward-biased diode PDIO and the turned-on MNESD between the VDD/VSS power rails. Similarly, the ND-mode ESD current is discharged according to the dashed line shown in FIG. 5 with the diode NDIO in the forward-biased condition and the turned-on device MNESD between the VDD/VSS power rails. The device MNESD especially provides a larger device dimension to sustain a high ESD current. The large-dimension device MNESD's large junction capacitance does not contribute to the RF input pad 31. Accordingly, the RF input diodes connected to the RF input pin can sustain much higher levels of four-mode ESD stress but only with small diodes connected to the RF input pad 31. Therefore, loading capacitance generated from the ESD protection devices to the RF input pad 31 can be significantly reduced. The performance of radio frequency integrated circuits(RFICs) is thereby not degraded significantly.

FIGS. 6 and 7 show ESD protection circuits disclosed in “Distributed ESD Protection for High-Speed Integrated Circuits”, IEEE Electron Device Letters, vol. 21, Aug. 2000, by Bendik Kleveland et al. FIG. 6 shows one stage matching structure, and FIG. 7 shows a four stage matching structure. FIGS. 8 and 9 show a roadmap in a Smith Chart with 1-stage and 4-stage distributed matching, respectively. In FIG. 8, the equivalent capacitance of ESD protection diodes CA and CB leads the route down following the circle in the Smith Chart from origin. The transmission line TL brings the route to the real axis of the Smith Chart. Similarly, in FIG. 9, the equivalent capacitance of ESD protection diodes CA4 and CB4 leads the route down following the circle in the Smith Chart. Each equivalent capacitance (CA3+CB3), (CA2+CB2) and (CA1+CB1) leads the route down following a circle in the Smith Chart, respectively. The transmission lines TL4, TL3, TL2, and TL1 bring the route to the real axis of the Smith Chart. In such a structure, all equivalent capacitances are the same, i.e.
(CA1++CB1)=(CA2+CB2)=(CA3+CB3)=(CA4+CBb4)

From the comparison between FIG. 8 and FIG. 9, it is found that increased stages in the ESD protection circuit with the same total equivalent capacitance move the end position of the route closer to the origin. The distance from the end position to the origin is proportional to the signal power loss. Multiple stage matching condition thus improves power gain. Since it is difficult to achieve uniform ESD current distribution among multiple separated ESD cells during fast ESD events, the first ESD cell, closest to the input pad, is typically damaged by ESD before the second or third cell is turned on to distribute current, resulting in low ESD tolerance in a real chip, even in the presence of multiple separated ESD protection cells.

### SUMMARY

An embodiment of an ESD protection circuit with impedance matching comprises a power rail, an ESD cell and a plurality of transmission lines. The transmission lines are connected in series between a pad and a radio frequency internal circuit. One node is disposed at each end of each transmission line. The ESD cell, comprising at least one ESD component, is coupled between each node and the power rail. The ESD cell closer to the pad withstands higher levels of ESD stress.

Another embodiment of an ESD protection circuit with impedance matching comprises a power rail, a plurality of transmission lines and a plurality of ESD components. The transmission lines are connected in series between a pad and a radio frequency internal circuit. One node is disposed at each end of each transmission line. At least one ESD component is coupled between each node and the power rail. All ESD components are identical and the number thereof coupled to each node differs from node to node.

Another embodiment of an ESD protection circuit with impedance matching comprises a power rail, a plurality of transmission lines and a plurality of ESD components. The transmission lines are connected in series between a pad and a radio frequency internal circuit. One node is disposed at each end of each transmission line. At least one ESD component is coupled between each node and the power rail. The transmission line brings the route across a real axis of the Smith Chart and at least one ESD component leads the route back to the real axis of the Smith Chart.

### BRIEF DESCRIPTION OF THE DRAWINGS

The present invention can be more fully understood from the detailed description given herein and the accompanying drawings, given by way of illustration only and thus not intended to be limitative.

FIG. 1 shows a two-stage protection structure of a conventional ESD protection circuit for digital ICs.

FIG. 2 shows four ESD stress modes encountered by integrated circuits.

FIG. 3 shows a conventional ESD protection circuit with double diodes and VDD to VSS power clamp circuit.

FIGS. 4 and 5 show ESD current paths in a conventional RF ESD protection circuit experiencing PS-mode and ND-mode ESD stresses, respectively.

FIGS. 6 and 7 show conventional 1-stage and 4-stage ESD protection circuits, respectively, with impedance matching.

FIGS. 8 and 9 show, respectively, the routes in a Smith Chart with 1-stage and 4-stage distributed matching.

FIG. 10 shows an ESD protection circuit with impedance matching according to an embodiment of the invention.

FIG. 11 shows the route in a Smith Chart shown in FIG. 10, of ESD protection circuits with impedance matching according to an embodiment of the invention.

FIG. 12 shows an n-stage distributed ESD protection scheme shown in FIG. 10, of ESD protection circuits with impedance matching according to an embodiment of the invention.

FIG. 13 shows another ESD protection circuit with impedance matching according to another embodiment of the invention.

FIG. 14 shows the route in a Smith Chart shown in FIG. 13, of ESD protection circuits with impedance matching according to another embodiment of the invention.

FIG. 15 shows an n-stage distributed ESD protection scheme shown in FIG. 13, of ESD protection circuits with impedance matching according to another embodiment of the invention.

FIG. 16 shows another ESD protection circuit with impedance matching according to another embodiment of the invention.

FIG. 17 shows the route in a Smith Chart shown in FIG. 16, of ESD protection circuits with impedance matching according to another embodiment of the invention.

FIG. 18 shows an n-stage distributed ESD protection scheme shown in FIG. 16, of ESD protection circuits with impedance matching according to another embodiment of the invention.

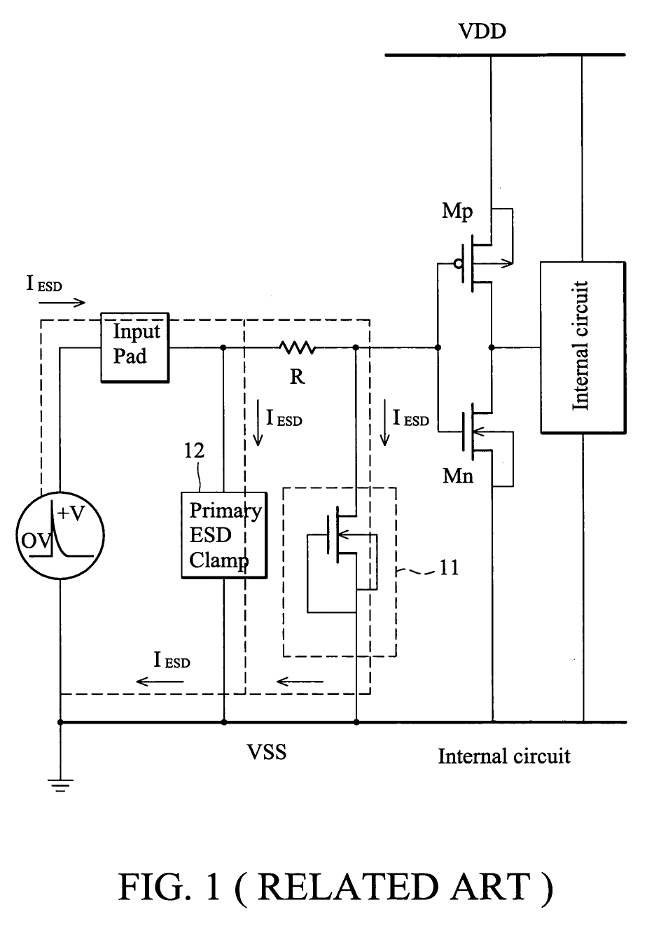

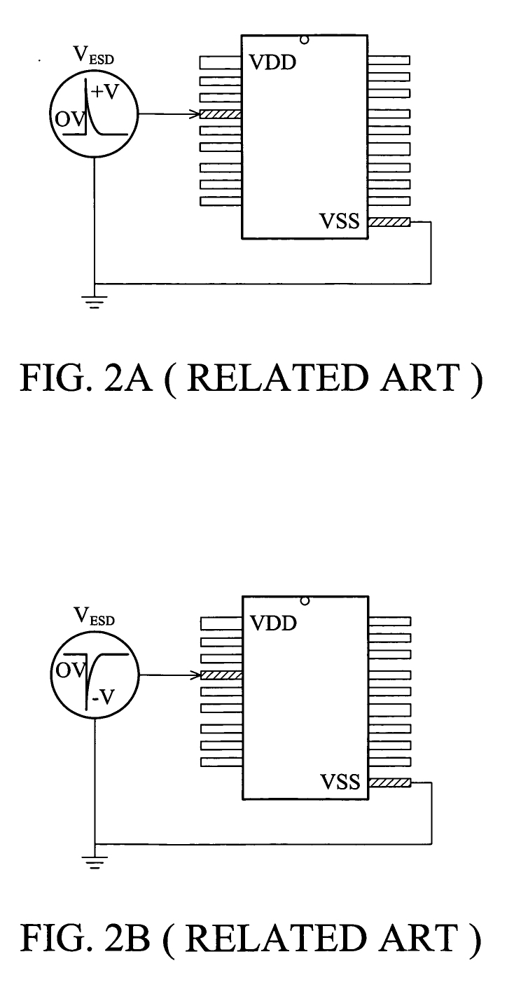

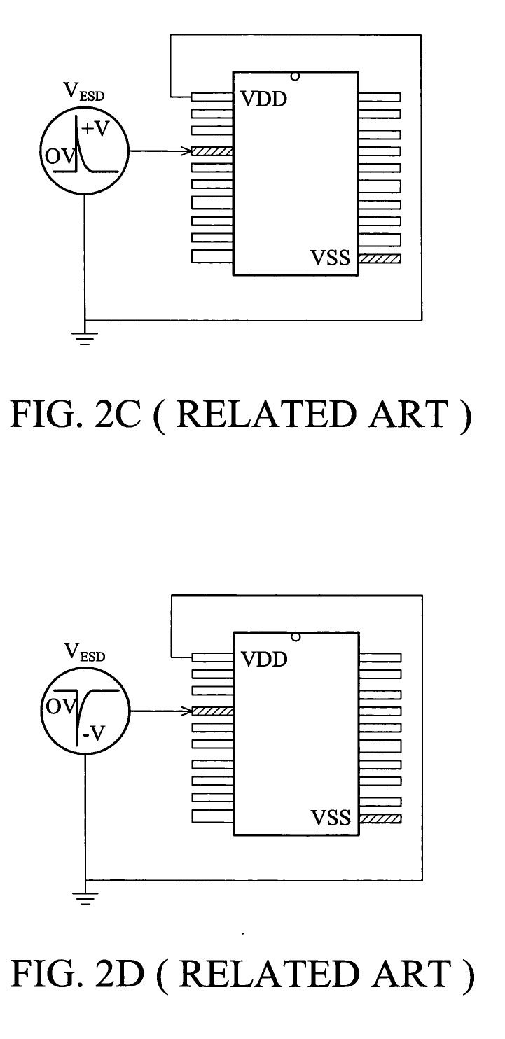

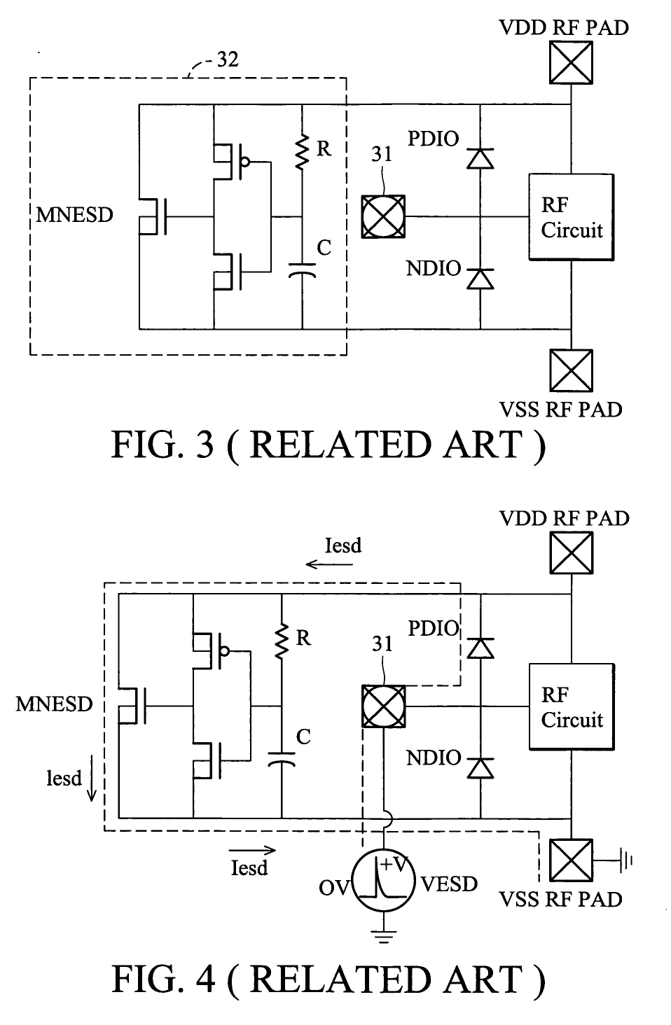

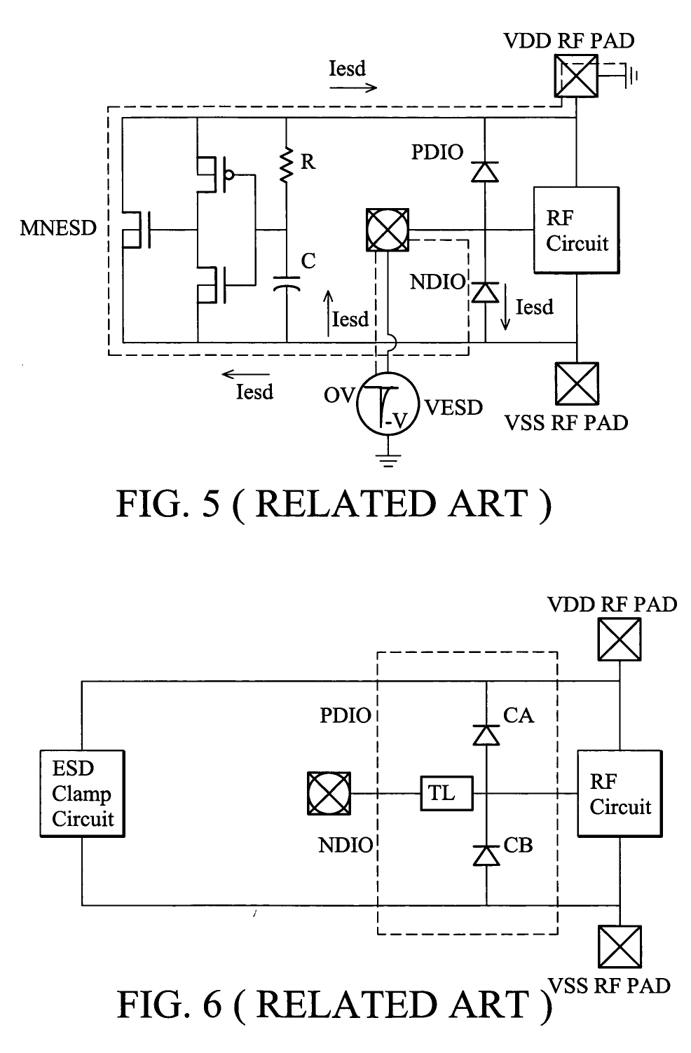

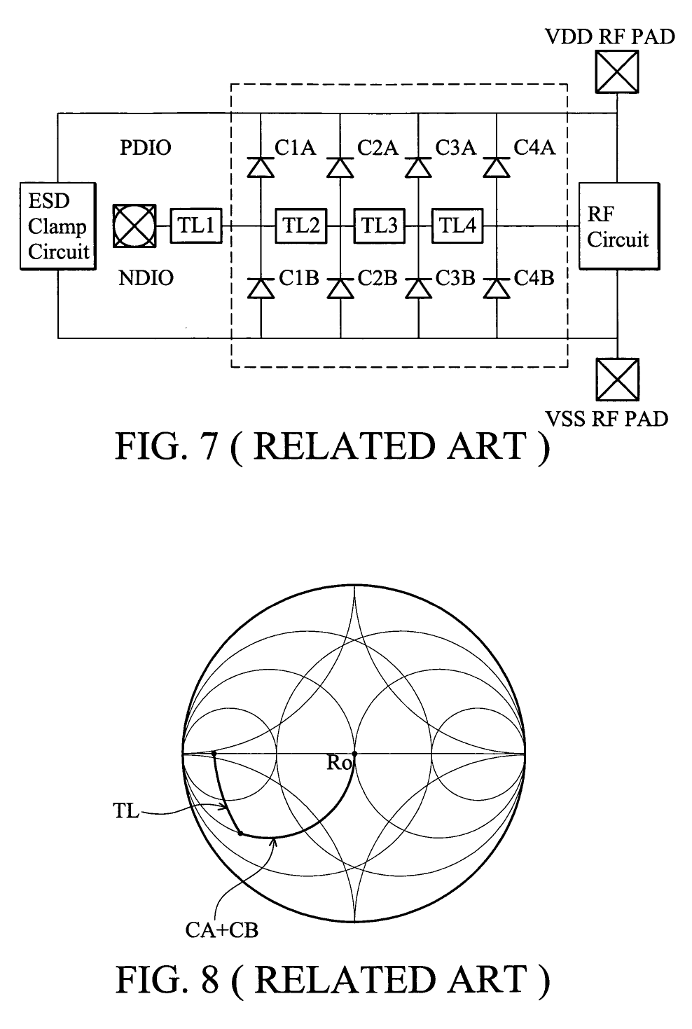

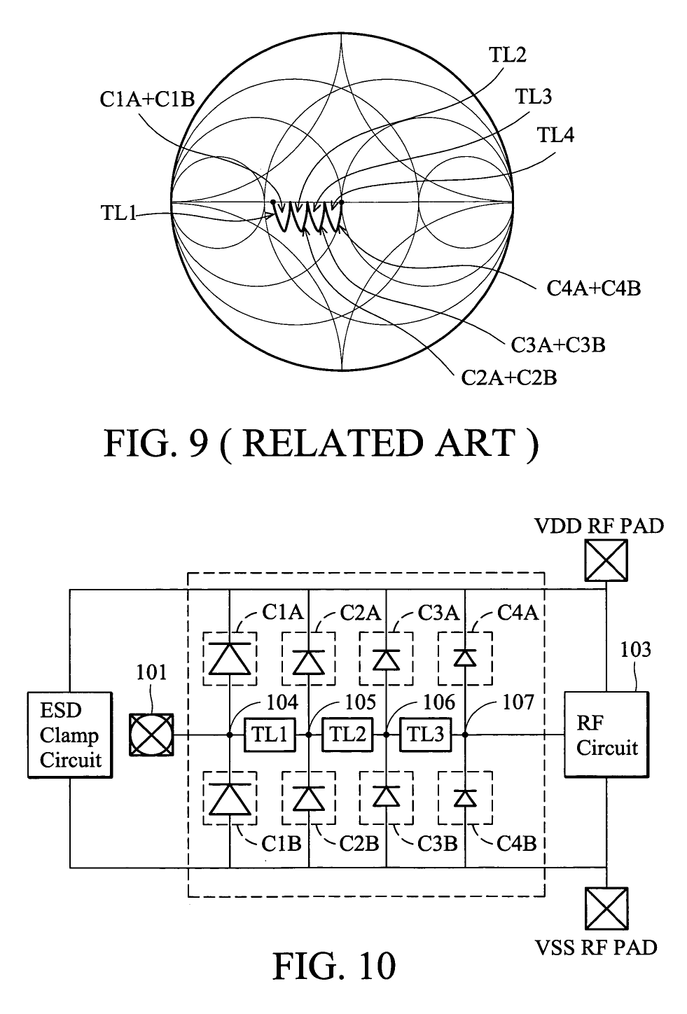

### DETAILED DESCRIPTION

As shown in FIG. 10, an ESD protection circuit with impedance matching according to an embodiment of the invention comprises power rails VDD/VSS, a plurality of transmission lines TL1-TL3 and a plurality of ESD cells C1A-C4A and C1B-C4B. Each ESD cell comprises an ESD component. As shown in FIG. 10, each ESD component is a diode. The transmission lines are connected in series between an input pad 101 and a radio frequency internal circuit 103. One node 104-107 is disposed at each end of each transmission line TL1-TL3. One ESD cell is coupled between each node 104-107 and the power rail VDD, with another coupled between each node 104-107 and the power rail VSS. In FIG. 10, the size and layout area of ESD diodes decreases from the input PAD 101 to internal RF circuit 103. In other words, the equivalent capacitance of ESD cells between each node 104-107 and the power rails VDD/VSS decreases from the input PAD 101 to the internal RF circuit 103. Since the main ESD discharge current follows the nearest path, i.e. through the diode C1A or C1B, to the input PAD 101, the larger layout area of the ESD diodes near the input PAD provides better performance of ESD protection.

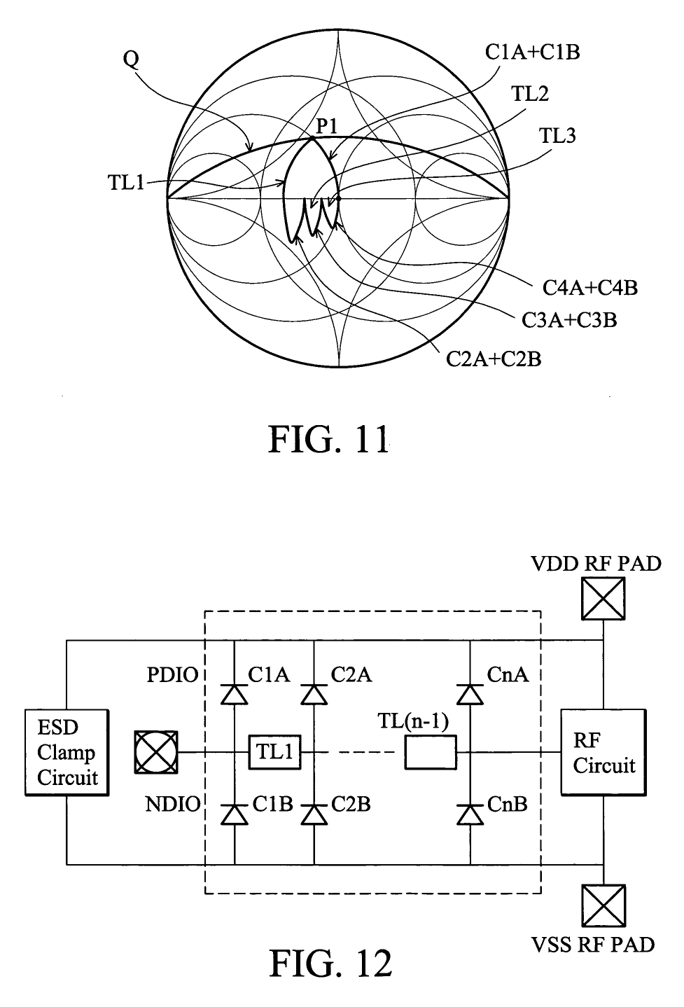

FIG. 11 shows the route in a Smith Chart shown in FIG. 10, of ESD protection circuits with impedance matching according to an embodiment of the invention. The route begins at the origin of the Smith Chart, and equivalent capacitance of the ESD cells C4A and C4B directs the route along a circle in the Smith Chart. The transmission line TL3 returns the route to the real axis of the Smith Chart. In the same way, the equivalent capacitance of the ESD cells C3A and C3B directs this route along another circle of the Smith Chart. The transmission line TL2 returns the route to the real axis of the Smith Chart. Again, the equivalent capacitance of the ESD cells C2A and C2B directs this route along another circle of the Smith Chart. The transmission line TL1 directs the route to the point P1 of the Smith Chart. Eventually, the equivalent capacitance of the ESD diodes C1A and C1B returns this route to the origin of the Smith Chart again. In other words, there is no power gain loss in the ESD protection circuit. The transmission lines TL1-TL3 can be implemented with an on-chip inductor or a bondwire inductor, for example. Furthermore, transmission lines TL1-TL3 can comprise a microstrip transmission line, a coplanar waveguide, or a coplanar stripline, for example. It is noted that construction of the ESD protection circuit with impedance matching according to an embodiment of the invention is not limited to 4 stages and can be expanded to an n-stage structure, as shown in FIG. 12.

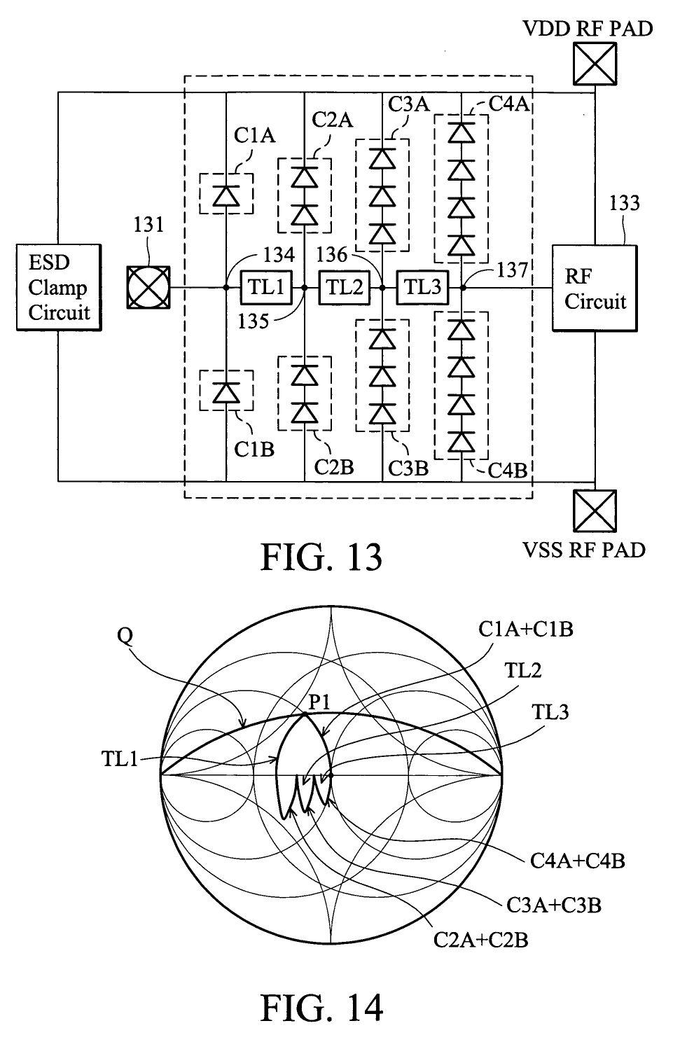

FIG. 13 shows another embodiment of ESD protection circuit with impedance matching according to an embodiment of the invention. As shown in FIG. 13, each ESD component is a diode. The layout area of each ESD diode is the same in an ESD protection circuit. The number of stacked diodes increases from an input PAD 131 to an internal RF circuit 133. In other words, the equivalent capacitance of the ESD cells C1A-C4A and C1B-C4B between each node 134-137 and the power rails VDD/VSS decreases from the input PAD 131 to the internal RF circuit 133. Since it is easier to turn on the ESD diode in ESD cells C1A or C1B, the main discharge ESD current follows the nearest path, i.e. through the ESD cell C1A or C1B, to the input PAD 131. As long as the ESD cells C1A and C1B can sustain high ESD stress, the internal RF circuit 133 is well protected.

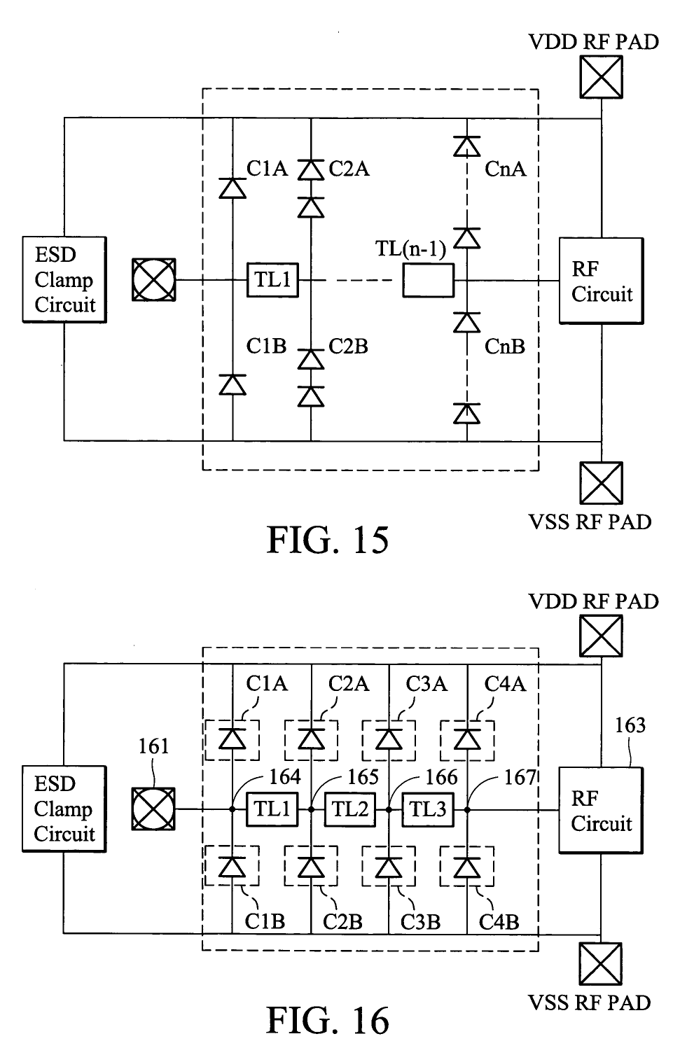

FIG. 14 shows the route in a Smith Chart shown in FIG. 13, of an ESD protection circuit with impedance matching according to another embodiment of the invention. The route begins at the origin of the Smith Chart, and the equivalent capacitance of the ESD cells C1A and C1B eventually returns this route to the origin of the Smith Chart again. The route follows a route similar to that shown in FIG. 11. In other words, there is no power gain loss in this ESD protection circuit. It is noted that construction of the ESD protection circuit with impedance matching according to an embodiment of the invention is not limited to 4 stages and can be expanded to an n-stage structure, as shown in FIG. 15.

FIG. 16 shows yet another ESD protection circuit with impedance matching according to another embodiment of the invention. As shown in FIG. 16, each ESD component is a diode. The layout area of the ESD diodes between each node 164-167 and the power rails VDD/VSS in the ESD protection circuit is the same. In other words, equivalent capacitance of the ESD cells is the same at each stage, i.e.
(C1A+C1B)=(C2A+C2B)=(C3A+C3B)=(C4A+C4B)

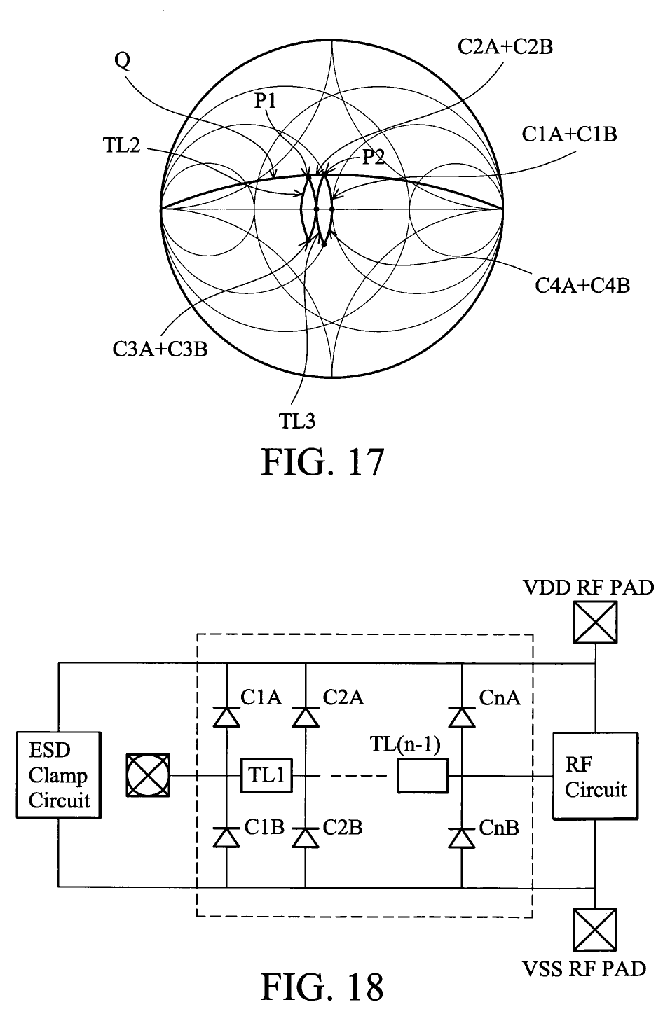

FIG. 17 shows the route in a Smith Chart shown in FIG. 16, of ESD protection circuits with impedance matching according to an embodiment of the invention. The route begins at the origin of the Smith Chart, and the equivalent capacitance of the ESD cells C4A and C4B directs this route along a circle of the Smith Chart. The transmission line TL3 returns the route to the real axis of the Smith Chart. In the same way, the equivalent capacitance of the ESD cells C3A and C3B directs this route along another circle of the Smith Chart. The transmission line TL2 directs the route to the point P1 of the Smith Chart. Again, the equivalent capacitance of the ESD cells C2A and C2B returns this route down to the real axis of the Smith Chart. Thereafter, the transmission line TL1 directs the route up the point P2 of the Smith Chart. Eventually, the equivalent capacitance of the ESD cells C1A and C1B directs this route to the origin of the Smith Chart again. In other words, there is no power gain loss in the ESD protection circuit. The route for this structure does not deviate significantly from the origin in the Smith Chart, indicating increased bandwidth. It is noted that construction of the ESD protection circuit with impedance matching according to an embodiment of the invention is not limited to 4 stages and can be expanded to an n-stage structure, as shown in FIG. 18.

While ESD components disclosed are directed to diodes, each may also be a resistor coupled in series with a diode, a MOS transistor, a resistor coupled in series with a MOS transistor, a SCR device, or combinations thereof.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An ESD protection circuit with impedance matching, comprising:
at least one transmission line, with a node at each end thereof, connected in series between a pad and a radio frequency internal circuit;
a power rail; and
an ESD cell, coupled between each node and the power rail, comprising at least one ESD component;
wherein the ESD cell closer to the pad withstands higher levels of ESD stress.

2. The ESD protection circuit as claimed in claim 1, wherein an equivalent capacitance of the ESD cell between each node and the power rail decreases from the pad to the radio frequency internal circuit.

3. The ESD protection circuit as claimed in claim 1, wherein the ESD component is a diode, a resistor coupled in series with a diode, a MOS transistor, a resistor coupled in series with a MOS transistor, a SCR device, or combinations thereof.

4. The ESD protection circuit as claimed in claim 1, wherein the transmission line is implemented with an on-chip inductor or a bondwire.

5. The ESD protection circuit as claimed in claim 1, wherein the transmission line is a microstrip transmission line, a coplanar waveguide, or a coplanar stripline.

6. The ESD protection circuit as claimed in claim 1, wherein increased proximity to the radio frequency internal circuit increases the number of the ESD components connected in series between each node and the power rail.

7. An ESD protection circuit with impedance matching, comprising:
at least one transmission line, with a node at each end thereof, connected in series between a pad and a radio frequency internal circuit;
a power rail; and
at least one ESD component coupled between each node and the power rail;
wherein all the ESD components are substantially identical and the number of the ESD components coupled between each node and the power rail differs from node to node.

8. The ESD protection circuit as claimed in claim 7, wherein the ESD component is a diode, a resistor coupled in series with a diode, a MOS transistor, a resistor coupled in series with a MOS transistor, a SCR device, or combinations thereof.

9. The ESD protection circuit as claimed in claim 7, wherein the transmission line is implemented with an on-chip inductor or a bondwire.

10. The ESD protection circuit as claimed in claim 7, wherein the transmission line is a microstrip transmission line, a coplanar waveguide, or a coplanar stripline.

11. An ESD protection circuit with impedance matching, comprising:
at least one transmission line, with a node at each end thereof, connected in series between a pad and a radio frequency internal circuit;
a power rail; and
an ESD component between each node and the power rail;
wherein the transmission line brings the route across a real axis of a Smith Chart; and at least one ESD component returns the route to the real axis of the Smith Chart.

12. The ESD protection circuit as claimed in claim 11, wherein the ESD component is a diode, a resistor coupled in series with a diode, a MOS transistor, a resistor coupled in series with a MOS transistor, a SCR device, or combinations thereof.

13. The ESD protection circuit as claimed in claim 11, wherein the transmission line is implemented with an on-chip inductor or a bondwire.

14. The ESD protection circuit as claimed in claim 11, wherein the transmission line is a microstrip transmission line, a coplanar waveguide, or a coplanar stripline.

15. The ESD protection circuit as claimed in claim 11, wherein the number of the ESD components coupled between each node and the power rail is the same from node to node.

16. The ESD protection circuit as claimed in claim 15, wherein all the ESD components are identical.
